(19) United States
(12) Patent Application Publication
(10) Pub. No.: US 2025/0086337 A1
(43) Pub. Date: Mar. 13, 2025

(54) SYSTEM AND METHOD FOR AUTONOMOUS SATELLITE CONFIGURATION UTILIZING DIGITAL MODELS

(71) Applicant: Copernicus Space Corporation, Billerica, MA (US)

(72) Inventors: Michael Snyder, Jacksonville, FL (US); William White, Naples, FL (US); Dustin Larsen, Jacksonville, FL (US)

(21) Appl. No.: 18/830,552

(22) Filed: Sep. 10, 2024

Related U.S. Application Data
(60) Provisional application No. 63/537,547, filed on Sep. 10, 2023.

(51) Int. Cl. G06F 30/15

(52) U.S. Cl. CPC G06F 30/15

(57) ABSTRACT

A system for creating a satellite design includes a satellite system design configurator, a satellite system validation subsystem, a dependent requirements generator subsystem, and a cost and completion estimator subsystem, wherein each subsystem comprises at least one processor. The subsystems operate in concert to enable the configurator to provide a repeatable satellite design based on one or more user inputs and one or more generative inputs. At least a portion of the inputs are received via at least one input device included with the system. The system further includes a viewing device to allow a user to view the results from the configurator. A method for creating the satellite design includes generating satellite dependent requirements based on received or predetermined parameters, creating the satellite design with the satellite system design configurator based on the generated satellite dependent requirements, and validating the satellite design.

### BACKGROUND

Spacecraft are vehicles that are designed to fly and operate in outer space. Even when multiple, identical spacecraft arm being built for the same intended purpose, during the build process, each usually still end up being built slightly different than the others. This results because when testing the spacecraft prior to launching it to orbit, if the spacecraft does not meet a particular design parameter or objective, whereas the other spacecraft may meet the particular design parameter or objective, that one that does not is reconfigured to meet the design parameter or objective. Therefore, even though each similarly built spacecraft may look the same superficially, there may still be seen or unseen differences when compared to others.

A small satellite, miniaturized satellite, or smallsat is a satellite of low mass and size. Smallsats are typically built small to reduce the large economic cost associated with the cost of launch vehicles and the costs associated with construction. Smallsats when used in number may be more useful than fewer, larger satellites, depending on the satellites' purpose.

Though processes are available to select components to manufacture a system, these systems do not provide a level of detail for a user to know whether the configuration will work and the timeline to complete the build, as non-limiting examples.

Manufacturers and users of satellites, where more than a single version or class of the satellite is needed, would benefit from a system and method to autonomously create repeatable manufactured satellites from a same group of components based on at least one of user input and generative input where each configured satellite design includes a confirmation that a configuration will be successful for the intended mission.

### SUMMARY

Embodiments relate to a system and method for creating a satellite design, wherein the design configuration is autonomously determined based on at least one of a user input and a generative input. The system comprises an input device for a user to input at least one of a value or situational information related to at least one of a payload requirement and a mission requirement. The system also comprises a satellite system design configurator, a satellite system validation subsystem, a dependent requirements generator subsystem and a cost and completion estimator subsystem, wherein each subsystem comprises at least one processor to provide for a repeatable result based on at least user input and a generative input as provided by the configurator. The system may further comprise a viewing device to provide an output for a user to view the results of the configurator.

The method comprises inputting at least one of a value and situational information related to at least one of a payload requirement and a mission requirement with an input device for a satellite and generating satellite dependent requirements based on at least one of the value and the situational information entered. The method further comprises designing the satellite with a satellite system design configurator based on the satellite dependent requirements generated. The method also comprises validating the satellite design and reporting the satellite design to a user with a viewing device.

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1 shows an embodiment of an overview of a process flow for a generative satellite design configurator;

FIG. 2 shows an embodiment of a flowchart illustrating steps in the generative satellite design configurator;

FIG. 3 shows a more detailed embodiment of the components that may be included in in the generative satellite design configurator;

FIG. 4 shows an embodiment of a flowchart illustrating steps to provide for an optimal design;

FIG. 5 shows an embodiment of input and several results provided by the system and method disclosed herein;

FIG. 6 shows an embodiment of generative design inputs and resulting outputs provided by the generative satellite design configurator;

FIG. 7 shows an embodiment of additional design inputs and resulting outputs;

FIG. 8 shows an embodiment of additional design inputs and resulting outputs that may be determined based on decision tree analysis;

FIG. 9 shows a first embodiment of more design inputs and resulting outputs that may be determined based on decision tree analysis;

FIG. 10 shows a second embodiment, based the flowchart of FIG. 4 of exemplary design inputs and a process resulting in an optimized satellite configuration;

FIG. 11 shows a third embodiment, based the flowchart of FIG. 4, of design inputs and a process resulting in an optimized satellite configuration;

FIG. 12 shows a fourth embodiment, based the flowchart of FIG. 4, of design inputs and a process resulting in an optimized satellite configuration;

FIG. 13 shows a fifth embodiment, based the flowchart of FIG. 4, of design inputs and a process resulting in an optimized satellite configuration;

FIG. 14 shows a sixth embodiment, based the flowchart of FIG. 4, of design inputs and a process resulting in an optimized satellite configuration;

FIG. 15 shows a seventh embodiment, based the flowchart of FIG. 4, of design inputs and a process resulting in an eighth optimized satellite configuration;

FIG. 16 shows a ninth embodiment, based the flowchart of FIG. 4, of design inputs and a process resulting in an optimized satellite configuration;

FIG. 17 shows a tenth embodiment, based the flowchart of FIG. 4, of design inputs and a process resulting in an optimized satellite configuration;

FIG. 18 shows an eleventh embodiment, based the flowchart of FIG. 4, of design inputs and a process resulting in an optimized satellite configuration;

FIG. 19 shows a twelfth embodiment, based the flowchart of FIG. 4, of design inputs and a process resulting in an optimized satellite configuration;

FIG. 20 shows a thirteenth embodiment, based the flowchart of FIG. 4, of design inputs and a process resulting in an optimized satellite configuration;

FIG. 21 shows an embodiment, based the flowchart of FIG. 4, of user inputs and internal inputs are provided to a process resulting in an optimized satellite configuration or model;

FIG. 22 shows an exemplary process of the generative process discussed herein;

FIG. 23 illustrate a non-limiting plurality of other options, variations and selections for the embodiments disclosed herein;

FIG. 24 shows additional options, variations and selections that may be included in FIG. 23;

FIG. 25 shows additional options, variations and selections that may be included in FIG. 23;

FIG. 26 shows an exemplary process flow how generative and user input specific to other subsystems may factor into generative inputs and outputs of other subsystems;

FIG. 27 shows an exemplary embodiment of a genetic algorithm; and

FIG. 28 shows block diagrams of an exemplary computer system.

### DETAILED DESCRIPTION

Embodiments are described herein with reference to the attached figures wherein like reference numerals are used throughout the figures to designate similar or equivalent elements. The figures are not drawn to scale and they are provided merely to illustrate aspects disclosed herein. Several disclosed aspects are described below with reference to non-limiting example applications for illustration. It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. The embodiments are not limited by the illustrated ordering of acts or events, as some acts may occur in different orders and/or concurrently with other acts or events. Furthermore, not all illustrated acts or events are required to implement a methodology in accordance with the embodiments.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Furthermore, unless otherwise clear from the context, a numerical value presented herein has an implied precision given by the least significant digit. Thus, a value 1.1 implies a value from 1.05 to 1.15. The term “about” is used to indicate a broader range centered on the given value, and unless otherwise clear from the context implies a broader range around the least significant digit, such as “about 1.1” implies a range from 1.0 to 1.2. If the least significant digit is unclear, then the term “about” implies a factor of two, e.g., “about X” implies a value in the range from 0.5X to 2X, for example, about 100 implies a value in a range from 50 to 200. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

Embodiments disclosed herein provide for a system and method autonomously generating a design of a satellite. The generated design is repeatable when building a plurality of satellites that will operate in a “swarm” configuration, more specifically when a plurality of satellites operates in concert to perform a defined mission where the satellites make decisions, typically independently, based on shared information. Repeatable may mean creating the same satellite or creating a satellite that is specific to a mission where the design of the satellite is based on at least one of the user input and generative input. In some implementations, a repeatable satellite design may comprise an optimized satellite design configuration.

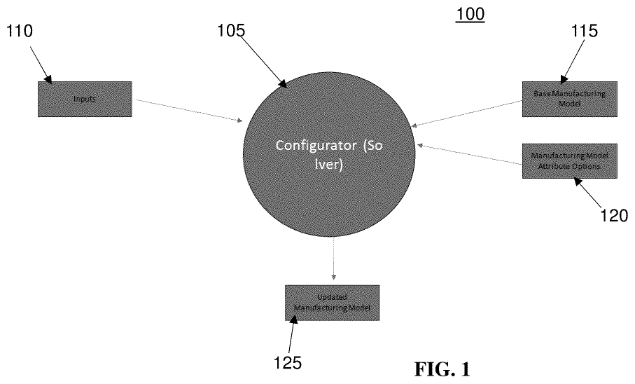

FIG. 1 shows an embodiment of an overview of a process flow 100 for a generative satellite design configurator or solver 105. “Generative,” as used herein, is not meant to be limiting. More specifically, generative is being used to describe being generated by one or more inputs 110 based on a philosophy (as may be programmed into a processor) instead of generated exactly by a direct algorithm. As shown, inputs 110 to the configurator may include data input by the user. Such information may include, but is not limited to, a digital model or even situational information. A base manufacturing model 115 may also be inputted. Furthermore, one or more manufacturing model attribute options 120 may also be inputted. Based on the various inputs 110, 115, 120, an output from the configurator may be an updated manufacturing model 125 that is determined based on the inputs 110, 115, 120 received.

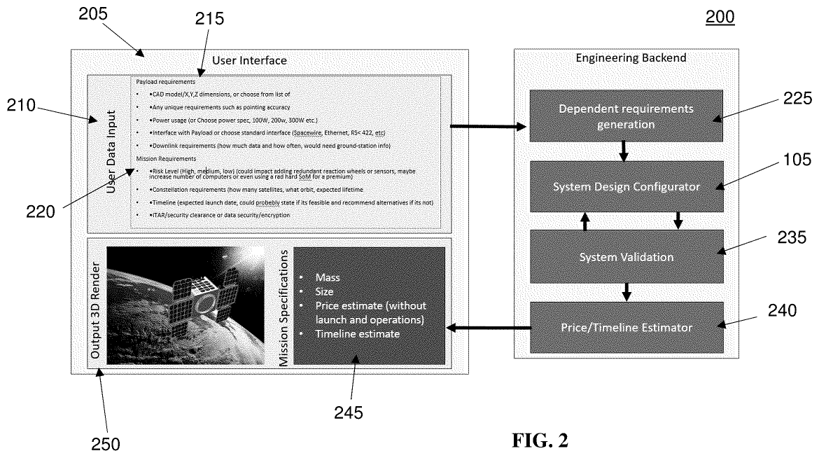

FIG. 2 shows an embodiment of a flowchart 200 illustrating steps in a generative satellite design configurator. As shown, a user interface 205 is provided. The user interface 205 may be an interface to a computing system, such as a data pad, keyboard, voice activation and receiving device, data transfer device, etc. The term “user interface” is not provided to be limiting herein. Non-limiting examples of the type of data 210 that may be inputted via the user interface 205 includes payload requirements 215 and mission requirements 220.

The payload requirements 215 may include, but are not limited to, computer aided design (“CAD”) model/X,Y,Z dimensions, or where such information may be chosen from list of dimension specifications, unique requirements specific to a mission, such as, but not limited to, pointing accuracy, power usage, interface requirements with a payload or selection of a standard interface, such as, but not limited to Spacewire™, Ethernet, RS<422, etc., and data downlink requirements or in other words, how much data and how often, whether ground-station information is needed, etc. which may be considered a digital model or even situational information.

The mission requirements 220 may include, but are not limited to, risk level (High, medium, low) which may impact adding redundant reaction wheels or sensors to the satellite, maybe increasing a number of computers or even using a radiation hardened adaptive system-on-module/system-on-chip (“SOM/SOC”), constellation requirements such as, but not limited to, how many satellites, what orbit, expected lifetime of the satellite, timeline to build, such as, but not limited to, an expected launch date and/or a feasibility determination, with recommend alternatives (in at least one of launch date, mission requirement and payload requirements), if the timeline is not possible, and international traffic in arms regulations (“ITAR”)/security clearance or data security/encryption.

The input data 210 is provided to at least one processor. The processor may include a machine learning or an artificial intelligence subsystem. The processor may have one or more sub processors or a single processor to provide for dependent requirements generation 225, system design configuration, system validation, and price/timeline estimation. As shown, resulting output from the dependent requirement generation 225 is provided to the system design configurator 105. An output from the system design configurator 105 is provided to the system validation subsystem 235. Output from the system validation subsystem 235 is provided back to the system design configurator 105 or subsystem, especially if the design fails validation, and to the price/timeline estimator 240 or subsystem. An output from the price/timeline estimator 240 may be provided to at least one viewing device for access by the user. The viewing device may be a part of the input device. The viewing device may provide visual imagery or audible output. The resulting information 245 provided to the user may include, but is not limited to any of, mass of the satellite, size of the satellite, price estimate (with and or without launch and operations costs), timeline estimate, etc. Furthermore, using digital modeling, a three-dimensional rendering 250 of the satellite is possible, as are two-dimensional and schematic renderings. The rendering 250 may be provided in a plurality of configurations, such as, but not limited to, a rotatable configuration, at the user desire, to illustrate various views, modeled as it would appear within a build area, within a launch device in orbit, in operation with others in the swarm, etc.

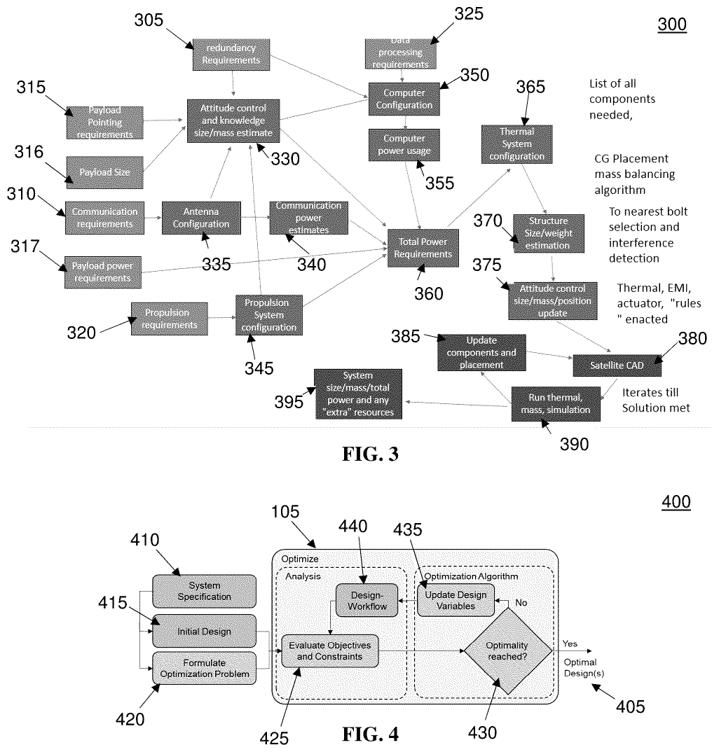

FIG. 3 shows a more detailed embodiment of the components 300 that may be included in or considered by the generative satellite design configurator 105. As non-limiting examples, other components 300 may include redundancy systems 305, communication requirements 310, information about the payload 315, 316, 317, propulsion requirements 320, data processing requirements 325, simulation results, etc. Since a center of gravity is important when launching a satellite into orbit, another output may include a center of gravity placement mass balancing algorithm. This information may be used in the rendering 250, especially when shown within a launch device. Furthermore, thermal, electromagnetic, actuator, etc. rules and requirements information may also be provided. Similarly, when required, specifics about the storage location on the launch device may also be input by the user.

In some aspects, the generative satellite design configurator 105 may be configured to perform or execute a plurality of functions or operations when generating an optimal design, including, by way of example and not limitation, one or more of: attitude control and knowledge size/mass estimation 330, antenna configuration 335, communication power estimation 340, propulsion system configuration 345, computer configuration 350, computer power usage determination 355, total power requirements determination 360, thermal system configuration 365, structure size/weight estimation 370, attitude control size/mass/position update 375, satellite CAD generation 380, thermal and mass simulation 390, components and placement update 385, and system size/mass/total power/extra resources determination 395. The generative satellite design configurator 105 may operate iteratively until an optimal solution is achieved. In some implementations, the functions or operations of the satellite design configurator 105 may be performed with some sequential considerations, as indicated by the arrows in FIG. 3; however, the functioning or operation of the satellite design configurator 105 is not limited to such sequential considerations.

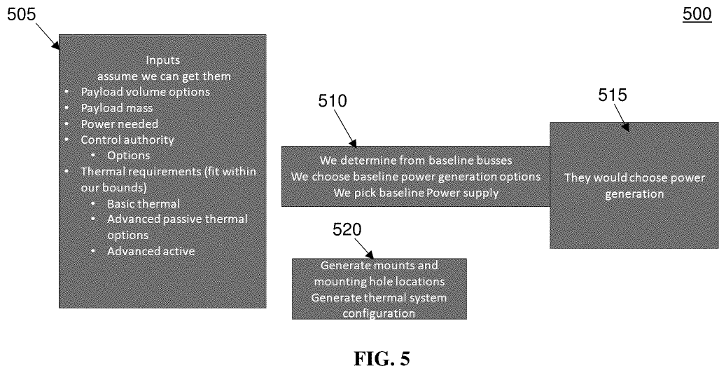

FIG. 4 shows a flowchart 400 of a process discussed above to provide one or more optimal satellite designs 405. The system or configurator 105 may continue to autonomously make analytical iterations within the confines of limitations either inputted by the user or preset until a build solution is achieved. A shown, the system specifications 410 are provided to the initial design determination 415 and to a subsystem 420 to formulate optimization of the need or problem. An output from the initial design subsystem 415 and optimization subsystem 420 is provided for analysis to an evaluation objective and constraints subsystem 425. An output is provided to facilitate a determination 430 whether optimality has been achieved. If yes, the optimal design 405 is reported to the user. If not, at least one processor, with its software or algorithm(s) (which may be machine learning technology) may update design variables 435 where the design workflow 440 is provided to the evaluate objectives and constraints subsystem 425 again for eventual determination 430 whether an optimal design 405 has been achieved. As discussed herein, this process may be undertaken with at least one processor.

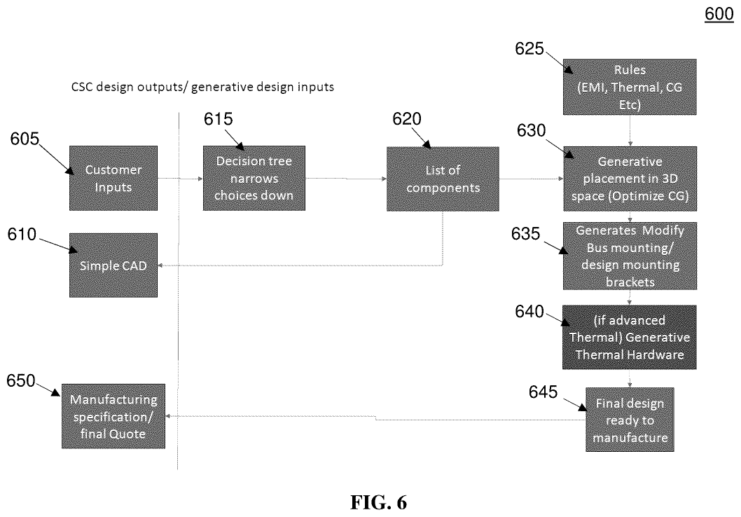

FIG. 5 shows an embodiment 500 of exemplary inputs 505, 510 and several results 515, 520 provided by the system and method disclosed herein. Input data 505 may include payload volume options, payload mass, power requirements, control authority including any options, thermal requirements, etc. The thermal requirements may further include basic thermal options, advanced passive thermal options, and advanced active thermal options. Other inputs 510 may include base bus parameters, baseline power generation options, or baseline power supply. The results 520 generated by the configurator 105 regarding the base bus parameters may include mount information including, but not limited to, mounting hole locations. Thermal information may produce thermal system configuration. Also, power inputs can result in power generation information 515.

Hence, as non-limiting examples, the configurator 105 may be used to determine at last one of a port size, volume, mass, control authority (or models that provide these parameters), bus size, actuator type and size, placement of actuators including possibly generating a mounting solution for the actuators, power requirements such as, but not limited to, baseline bus range of power, payload size, etc.

FIGS. 6-9 show embodiments 600, 700, 800, 900 of design inputs and resulting outputs provided by the generative satellite design configurator 105. FIG. 6 shows that user inputs 605 are provided. A result back to the customer may be a computer aided design 610 (“CAD”) including a list of components as determined by the configurator 105. As shown, a decision tree 615 narrows options resulting in the list of components 620. The generator further considers one or more preset rules 625 to further optimize aspects of the satellite design (such as, but not limited to, optimizing a center of gravity of the spacecraft via generative placement in 3D space 630, generating or modifying bus mounting and/or designing one or more mounting brackets 635, or facilitating generative thermal hardware 640). A final design 645 is created and an output 650 is provided to the user including manufacturing specification which may include a quote to build or manufacture.

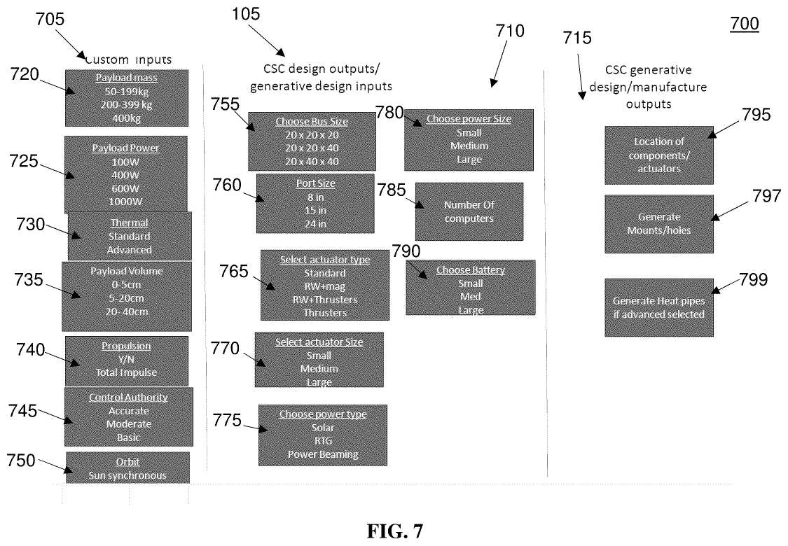

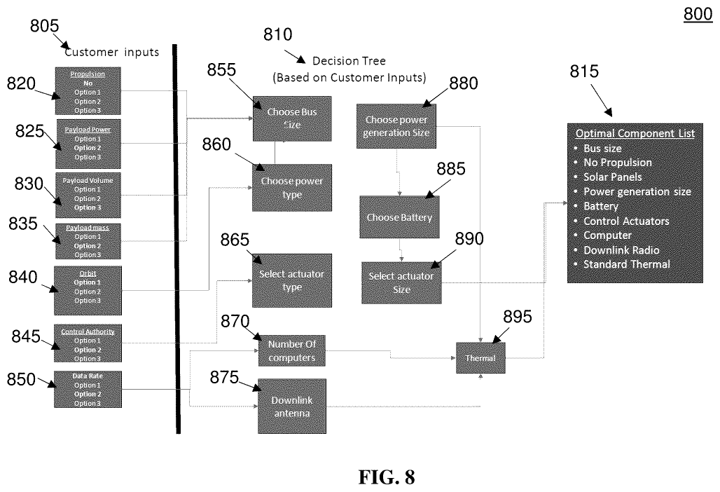

FIG. 7 shows an embodiment 700 of additional design inputs and resulting outputs. As shown, user inputs 705 are provided to the configurator 105, which then provides outputs 715 based on both the user inputs 705 and the configurator (generative design) inputs 710. One or more generative design or manufacture outputs 715 are then provided.

By way of example and not limitation, user inputs 705 may include one or more of: payload mass 720 (which may, in some aspects, comprise a payload mass range), payload power 725, thermal options 730 (such as, for example and not limitation, standard or advanced), payload volume 735 (which may, in some aspects, comprise a payload volume range), propulsion options 740 (such as, for example and not limitation, whether the design includes propulsion and the total impulse of the propulsion), control authority level 745 (such as, for example and not limitation, accurate, moderate, or basic), and orbit setting 750 (such as, for example and not limitation, sun synchronous).

By way of further example and not limitation, the generative design inputs 710 may comprise one or more of: a bus size 755, a port size 760, an actuator type selection 765 (such as, for example and not limitation, standard, RW+mag, RW+thrusters, or thrusters), an actuator size selection 770 (such as, for example and not limitation, small, medium, or large), a power type selection 775 (such as, for example and not limitation, solar, RTG, or power beaming), a power size selection 780 (such as, for example and not limitation, small, medium, or large), a number of computers indication 785, and a battery selection 790 (such as, for example and not limitation, small, medium, or large).

By way of still further example and not limitation, the generative design or manufacture outputs 715 may comprise one or more of: a location of one or more components 795 (such as, for example and not limitation, a location of one or more actuators), a generation of one or more mounts or holes 797, or a generation of one or more heat pipes 799. In some aspects, any generated component(s) may comprise one or more coupons that may be subjected to destructive testing, which may occur autonomously.

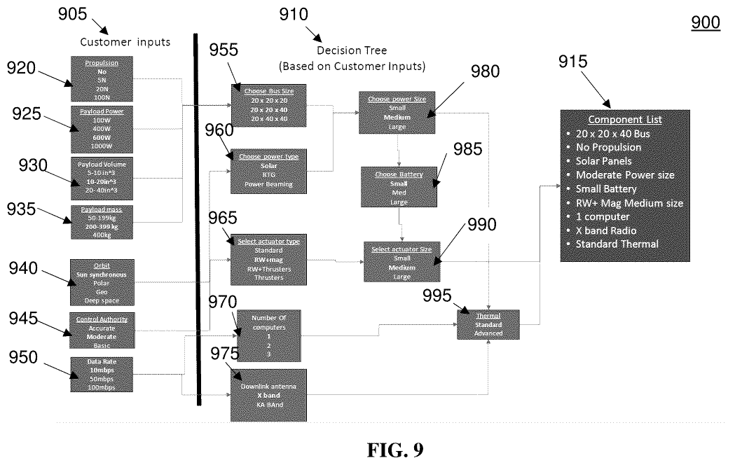

FIGS. 8 and 9 show exemplary embodiments 800, 900 of additional design inputs 805, 905 and resulting outputs 815, 915 that may be determined based on decision tree 810, 910 analysis. Based on the user inputs 805, 905 and decision tree 810, 910 analysis, a component list 815, 915 is an end result.

As a non-limiting illustrative example, design inputs 805 may comprise a propulsion option 820 of “no,” a selected payload power option 825, a selected payload volume option 830, a selected payload mass option 835, a selected orbit option 840, a selected control authority option 845, and a selected data rate option 850. The decision tree 810 may then be implemented to choose a bus size 855 based at least on one or more of the selected propulsion option 820, payload power option 825, payload volume option 830, and payload mass option 835. Further, the decision tree 810 may facilitate selection of a power type 860, based at least on the selected orbit option 840, while also taking into account the selected bus size. Additionally, the decision tree 810 may use the selected data rate option 850 to determine a number of computers 870 and a downlink antenna 875. Still further, the decision tree 810 may be configured to choose a power generation size 880, which may be used to select a battery 885, which may in turn facilitate selection of an actuator size 890. The selected power generation size 880, number of computers 870, and downlink antenna 875 may be factors used by the decision tree 810 when taking into account thermal options or factors 895. Ultimately, the output of the decision tree 810 analysis may produce the component list 815.

As an addition non-limiting illustrative example, design inputs 905 that comprise a propulsion option 920 selection of “no,” a payload power option 925 selection of 600 W, a payload volume option 930 selection of 10-20 in³, a payload mass option 935 selection of 200-399 kg, an orbit option 940 selection of “sun synchronous,” a control authority option 945 selection of “moderate,” and a data rate option 950 selection of 10 mbps may cause the decision tree 910 analysis to determine the selection of a bus size option 955 of 20×20×40, a power type option 960 selection of “solar,” an actuator type option 965 selection of “RW+mag,” a number of computers option 970 selection of 1, a downlink antenna option 975 selection of “X band,” a power size option 980 selection of “medium,” a battery option 985 selection of “small,” an actuator size option 990 selection of “medium,” and a thermal option 995 selection of “standard,” which may result in a displayed component list 915 reflecting the selections.

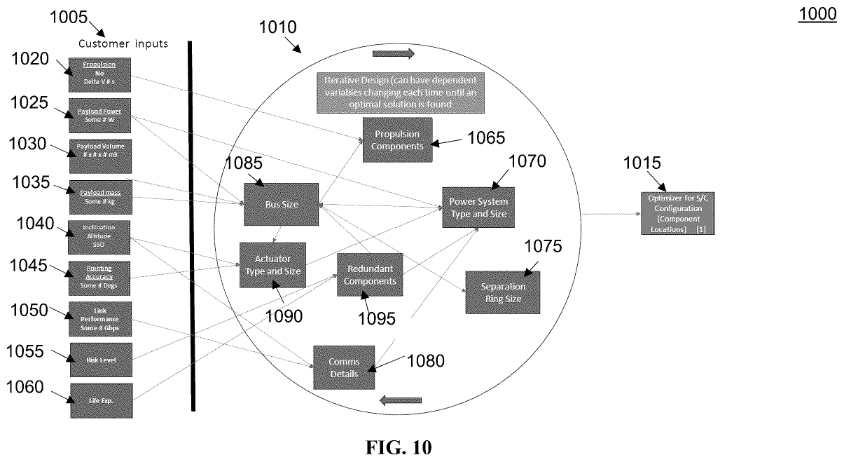

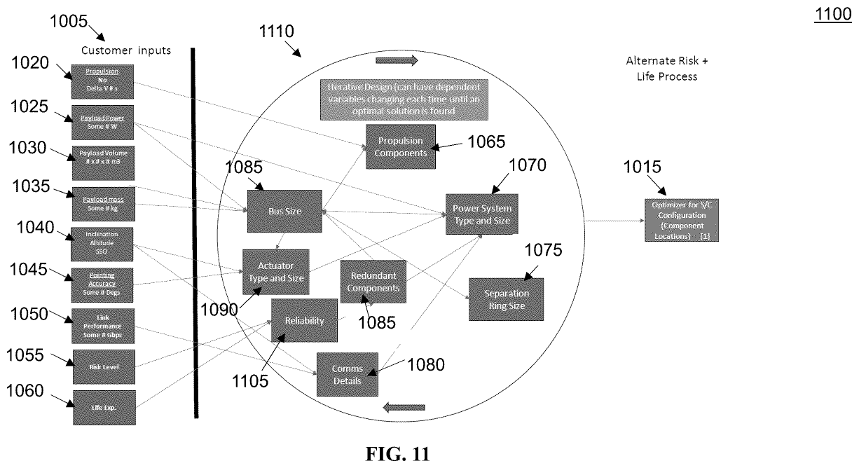

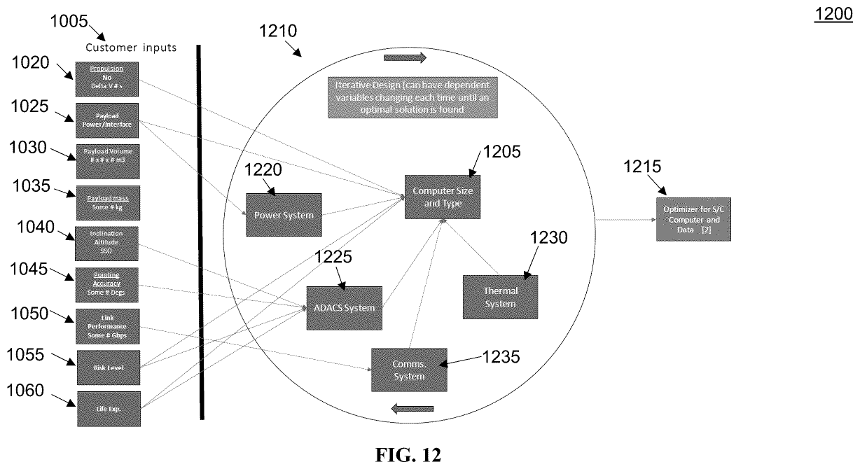

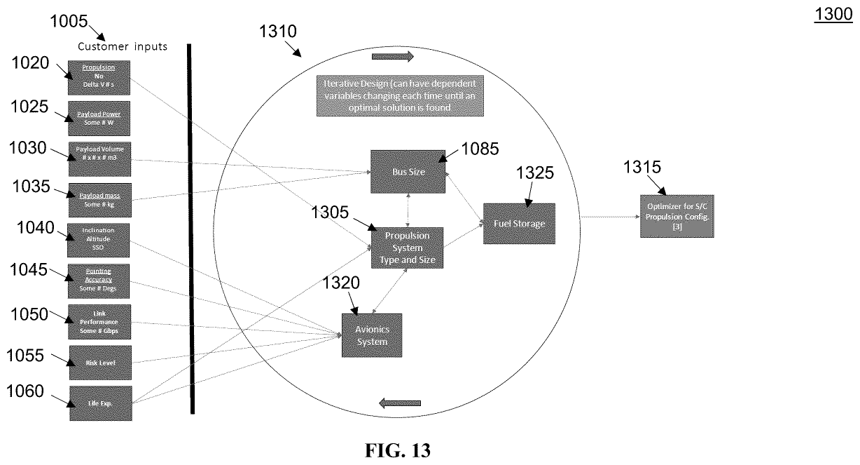

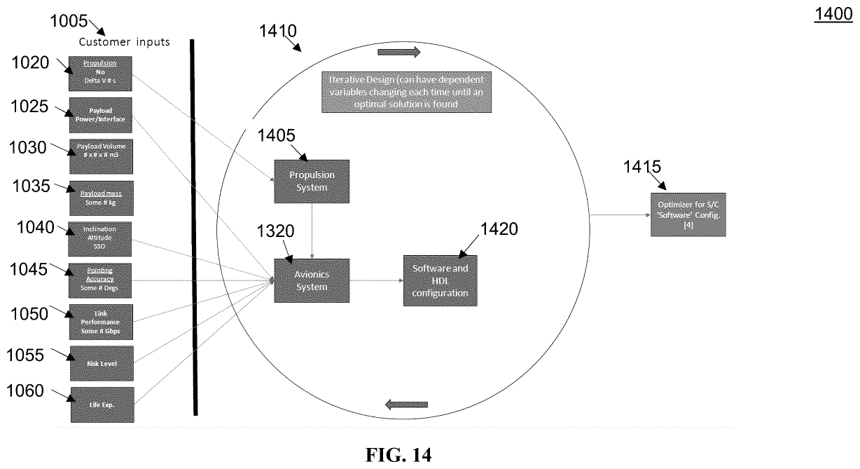

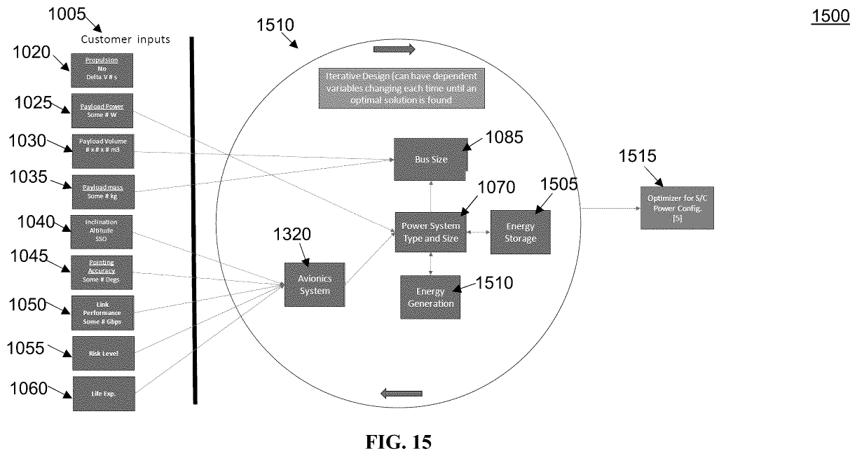

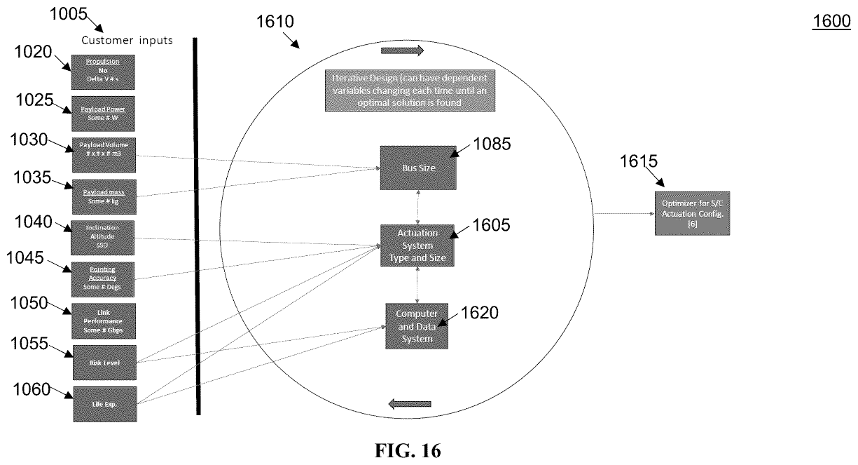

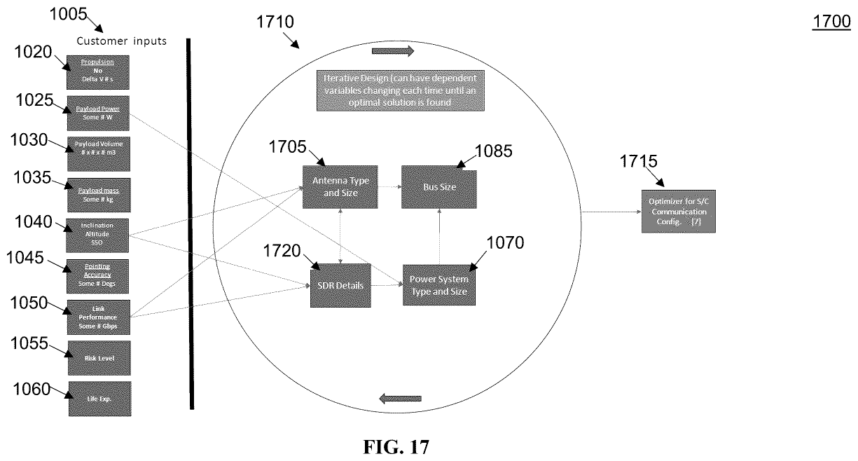

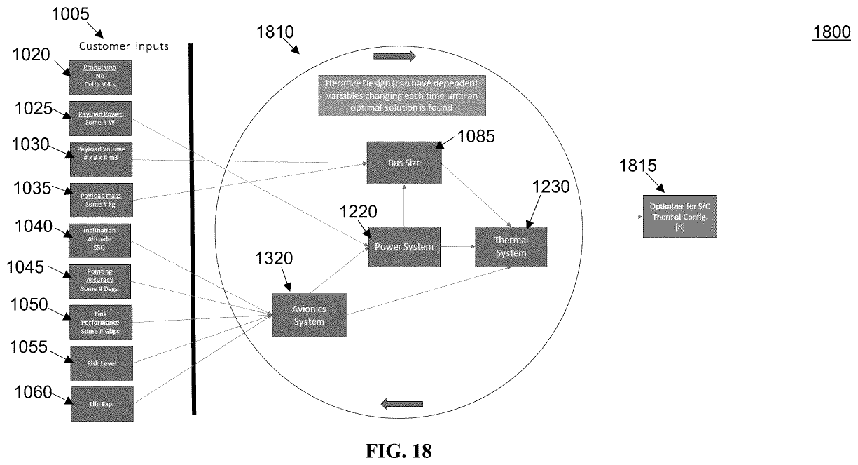

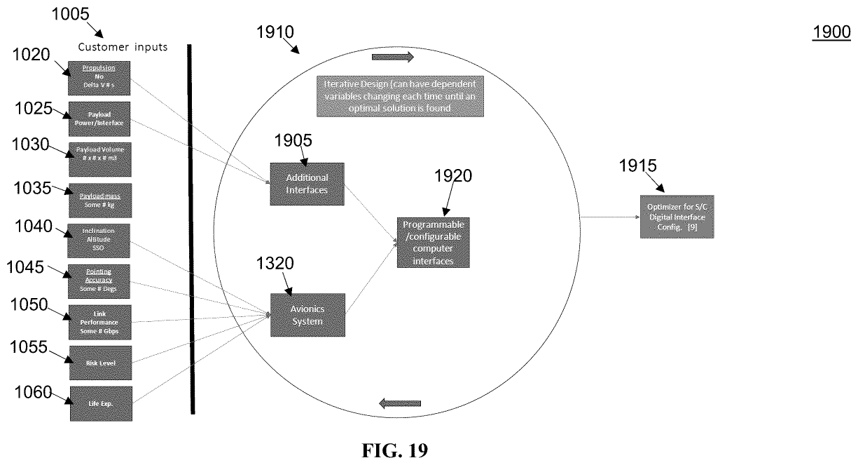

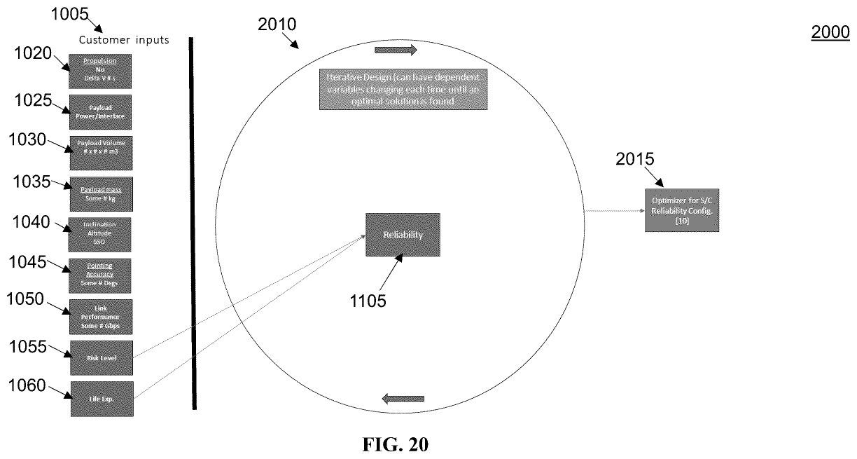

FIGS. 10-20 show embodiments 1000, 1100, 1200, 1300, 1400, 1500, 1600, 1700, 1800, 1900, 2000, based the flowchart of FIG. 4, of design inputs 1005, 1105, 1205, 1305, 1405, 1505, 1605, 1705, 1805, 1905, 2005, and processes 1010, 1110, 1210, 1310, 1410, 1510, 1610, 1710, 1810, 1910, 2010 resulting in at least a portion of an (or a complete) optimized satellite configuration 1015, 1115, 1215, 1315, 1415, 1515, 1615, 1715, 1815, 1915, 2015. The processes 1010, 1110, 1210, 1310, 1410, 1510, 1610, 1710, 1810, 1910, 2010 provide for an iterative design, which may, in some aspects, by autonomously performed by the satellite design configurator 105, and which may have dependent variables that change or are adjusted each time, and, in some aspects, in real time, until an optimal solution or configuration 1015, 1115, 1215, 1315, 1415, 1515, 1615, 1715, 1815, 1915, 2015 is found or determined. The resulting design 1015, 1115, 1215, 1315, 1415, 1515, 1615, 1715, 1815, 1915, 2015 is considered an optimized aspect for the satellite, where the aspect may be, but is not limited to, component location, type of component, etc. As non-limiting examples, FIG. 10 may provide for location of a specific component 1015 based at least on one or more design inputs 1005 that comprise a propulsion input 1020, a payload power input 1025, a payload volume input 1030, a payload mass input 1035 input, an inclination altitude input 1040, a pointing accuracy input 1045, a link performance input 1050, a risk level input 1055, and a life expectancy input 1060 using iterative process 1010 that includes changeable dependent variables including propulsion components 1065, power system type and size 1070, separation ring size 1075, comms details 1080, bus size 1085, actuator type and size 1090, and redundant components 1095. FIG. 11 may provide for an alternate location 1115 based at least on one or more of the design inputs 1005 when an alternate risk assessment 1055 or life expectancy 1060 is considered, wherein the iterative process 1110 includes reliability 1105 as an additional changeable dependent variable. FIG. 12 may provide for optimization 1215 of computing hardware and software and how data is handled through such subsystems based at least on one or more of the design inputs 1005 using iterative process 1210 that includes changeable dependent variables that comprise computer size and type 1205, power system 1220, ADACS system 1225, thermal system 1230, and communications system 1235. FIG. 13 may provide for propulsion system configuration 1315 based at least one or more of the design inputs 1005 using iterative process 1310 that includes changeable dependent variables that comprise bus size 1085, propulsion system type and size 1305, avionics system 1320, and fuel storage 1325. FIG. 14 may provide for software configuration 1415 based at least on one or more of the design inputs 1005 using iterative process 1410 that includes changeable dependent variables that comprise propulsion system 1405, avionics system 1320, and software and HDL configuration 1420. FIG. 15 may provide for power subsystem configuration 1515 based at least on one or more of the design inputs 1005 using iterative process 1510 that includes changeable dependent variables that comprise bus size 1085, power system type and size 1070, energy storage 1505, avionics system 1320, and energy generation 1510. FIG. 16 may provide for actuator configuration 1615 based at least on one or more of the design inputs 1005 using iterative process 1610 that includes changeable dependent variables that comprise bus size 1085, actuation system type and size 1605, and computer and data system 1620. FIG. 17 may provide for communication subsystem configuration 1715 based at least on one or more of the design inputs 1005 using iterative process 1710 that includes changeable dependent variables that comprise antenna type and size 1705, bus size 1085, SDR details 1720, and power system type and size 1070. FIG. 18 may provide for thermal management configuration 1815 based at least on one or more of the design inputs 1005 using iterative process 1810 that includes changeable dependent variables that comprise bus size 1085, power system 1220, thermal system 1230, and avionics system 1320. FIG. 19 may provide for digital interface configuration 1915 based at least on one or more of the design inputs 1005 using iterative process 1910 that includes changeable dependent variables that comprise additional interfaces 1905, programmable/configurable computer interfaces 1920, and avionics system 1320. FIG. 20 may provide for subsystem reliability configuration 2015, such as, but not limited to hardening determination and redundancy determination, based at least on one or more of the design inputs 1005 using iterative process 2010 that includes reliability 1105 as a changeable dependent variable. FIGS. 10-20 are not limiting as other similar processes may be generated for other aspects of a satellite design.

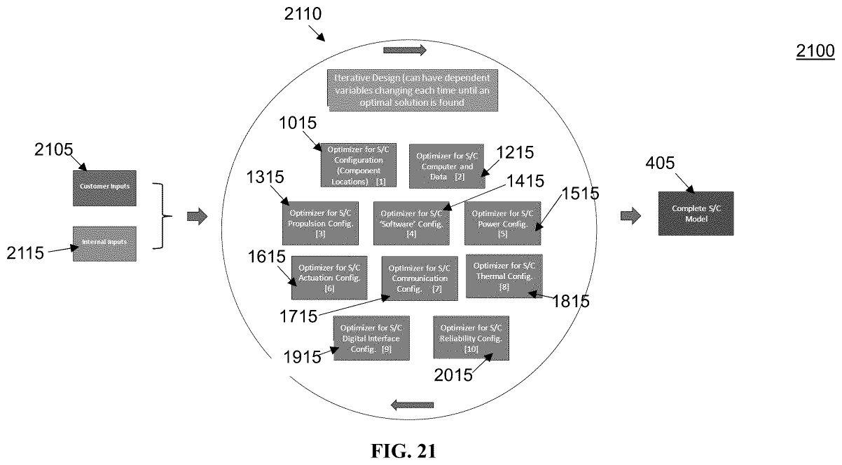

FIG. 21 shows an embodiment 2100, based on the flowchart of FIG. 4, of where user input 2105 and internal input 2115 may be used to provide the completed satellite configuration or model 405. As disclosed, the end products 1015, 1215, 1315, 1415, 1515, 1615, 1715, 1815, 1915, 2015 discussed above with respect to FIGS. 10-20 are utilized iteratively via a process 2110 as depicted in the flowchart of FIG. 4 to produce a complete model design 405.

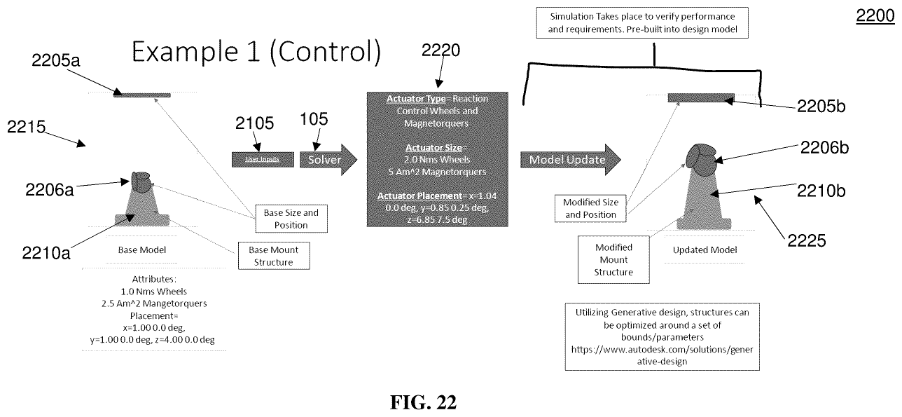

FIG. 22 shows an exemplary process 2200 of the generative process discussed herein. The component determined are actuators 2205a-b, 2206a-b, and a mount 2210a-b. As shown, a base model 2215 is provided as at least a portion of user inputs 2105 wherein certain attributes are identified. The generative process 2200 uses solver 105 to determine such factors 2220 as actuator type, size, placement, etc. Based on modeling and subsequent simulation(s), an updated model 2225 specific to the actuator(s) 2205b, 2206b, and mount 2210b are provided.

In some aspects, the generative process 2200 may iterate autonomously until an optimized design is reached. During subsequent iterations, an autonomous comparison between the base model 2215 (or any previous model iteration) and the most recent (or current) updated model 2225 may be performed. If a design is determined by the evaluate objectives and constraints subsystem 425 (shown in FIG. 4) to not be optimized, the design may be autonomously rejected.

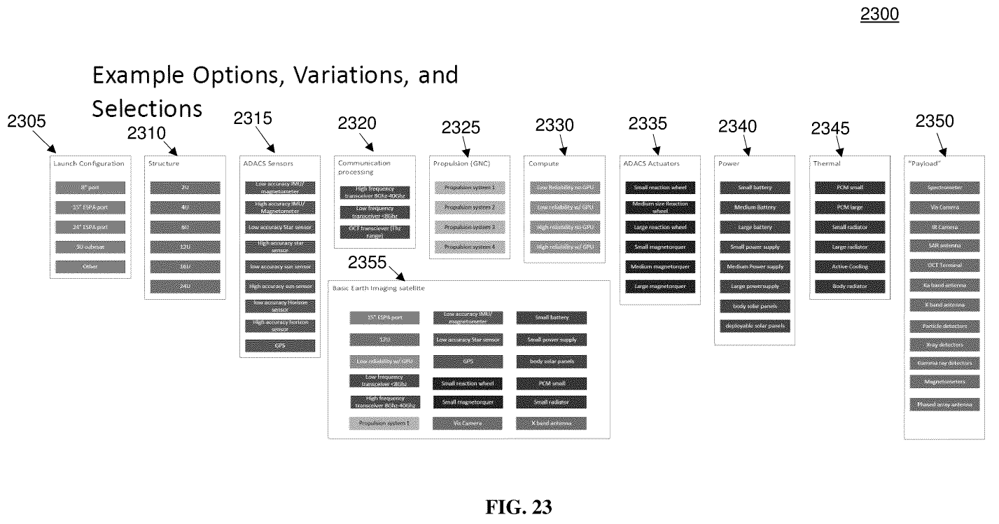

FIG. 23-25 illustrate a non-limiting plurality of other options, variations and selections for the embodiments disclosed herein. Each option, variation and selection may be included or evaluated in FIGS. 1 and 2, namely with the configurator disclosed herein.

With respect to FIG. 23, a plurality of exemplary options, variations, and selections are provided. By way of example and not limitation, such exemplary options and variations 2300 may pertain to and include launch configuration 2305 (such as, for example and not limitation, 8″ port, 15″ ESPA port, 24″ ESPA port, or 3U cubesat), structure 2310 (such as, for example and not limitation, 2U, 4U, 6U, 12U, 16U, or 24U), ADACS sensors 2315 (such as, for example and not limitation, low accuracy IMU/magnetometer, high accuracy IMU/magnetometer, low accuracy star sensor, high accuracy star sensor, low accuracy sun sensor, high accuracy sun sensor, low accuracy horizon sensor, high accuracy horizon sensor, or GPS), communication processing 2320 (such as, for example and not limitation, high frequency transceiver 8 Ghz-40 Ghz, low frequency transceiver less than 8 Ghz, or OCT transceiver (Thz range), propulsion (GNC) 2325 (such as, for example and not limitation, propulsion system 1, propulsion system 2, propulsion system 3, or propulsion system 4), computing 2330 (such as, for example and not limitation, low reliability without a GPU, low reliability with a GPU, high reliability without a GPU, or high reliability with a GPU), ADACS actuators 2335 (such as, for example and not limitation, small reaction wheel, medium size reaction wheel, large reaction wheel, small magnetorquer, medium magnetorquer, or large magnetorquer), power 2340 (such as, for example and not limitation, small battery, medium battery, large battery, small power supply, medium power supply, large power supply body solar panels, or deployable solar panels), thermal 2345 (such as for example and not limitation, PCM small, PCM large, small radiator, large radiator, active cooling, or body radiator), and payload 2350 (such as, for example and not limitation, spectrometer, vision camera, infrared camera, SAR antenna, OCT terminal, Ka band antenna, X band antenna, particle detectors, X-radiation detectors, gamma ray detectors, magnetometers, or phased array antenna).

As a non-limiting illustrative example, exemplary selections of the options and variations 2300 may comprise a basic earth imaging satellite 2355 that comprises a 15″ ESPA port, 12U structure, computing that comprises low reliability with a GPU, a low frequency transceiver, a high frequency transceiver, propulsion system 1, a low accuracy IMU/magnetometer, a low accuracy star sensor, a GPS, a small reaction wheel, a small magnetorquer, a vision camera, a small battery, a small power supply, body solar panels, a small PCM, a small radiator, and an X band antenna.

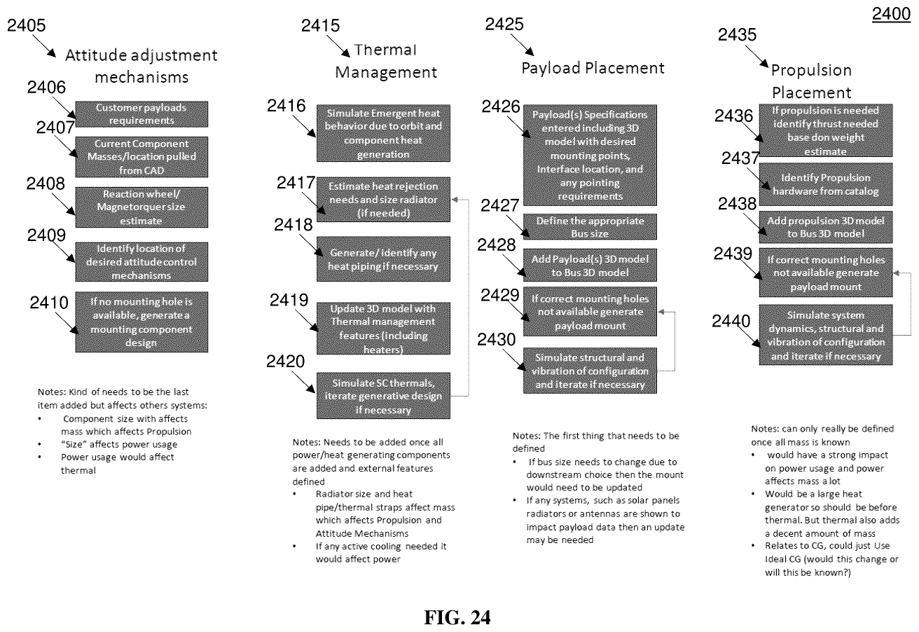

By way of example and not limitation, with respect to FIG. 24, attitude adjustment mechanisms 2405 are provided with various subsets 2406, 2407, 2408, 2409, 2410. A thermal management subsystem 2415 may also be provided. Also shown are payload specific information/inputs 2425 are provided. A propulsion subsystem placement 2435 is also shown.

In some non-limiting exemplary embodiments, the attitude adjustment mechanisms 2405 may include customer payload requirements 2406, information 2407 regarding current component masses and/or locations pulled from one or more CAD files, a reaction wheel/magnetorquer size estimate 2408, identification of the location of desired attitude control mechanisms 2409, and the generation of a mounting component design 2410 if no mounting hole is available. In some aspects, the size of each component affects mass, which affects propulsion considerations. Component size also affects power usage, which influences thermal considerations.

In some implementations, the thermal management subsystem 2415 may include simulation 2416 of emergent heat behavior due to orbit and component heat generation, estimation 2417 of heat rejection needs and radiator size (if needed), generation or identification 2418 of any heat piping that may be necessary, updating 2419 of a 3D model with thermal management features, including heaters, and simulation 2420 of SC thermals, using iterative generative design, if necessary. In some aspects, the thermal management subsystem needs to be implemented once all relevant power/heat generating components have been added and any external features have been defined. The radiator size and heat pipe/thermal straps affect mass with affects propulsion and the attitude adjustment mechanisms. Additionally, any required active cooling affects power.

In some embodiments, the payload specific information/inputs 2425 may include the input of one or more payload specifications 2426, including one or more 3D models with desired mounting points, interface location(s), and any pointing parameters; a defined appropriate bus size 2427, the addition 2428 of the 3D model of the payload(s) to the bus 3D model, generation of payload mount(s) 2429 if correct mounting holes are not available, and the simulation of the structural and vibration configuration, using iteration, if necessary. If the bus size needs to be changed due to one or more other design choices, then the mount may need to be updated. In some aspects, an update may be required if any systems, such as, for example and not limitation, solar panels, radiators, or antennas are determined to impact payload data.

In some implementations, the propulsion subsystem placement 2435 may include a determination 2436 as to whether propulsion is needed and an identification of thrust need based on weight estimate, and identification 2437 of propulsion hardware as derived from catalog, the addition 2438 of the propulsion 3D model to the bus 3D model, the generation 2439 of a payload mount if correct mounting holes are not available, and the simulation 2440 of system dynamics and structural and vibration of configuration, using iteration, if necessary.

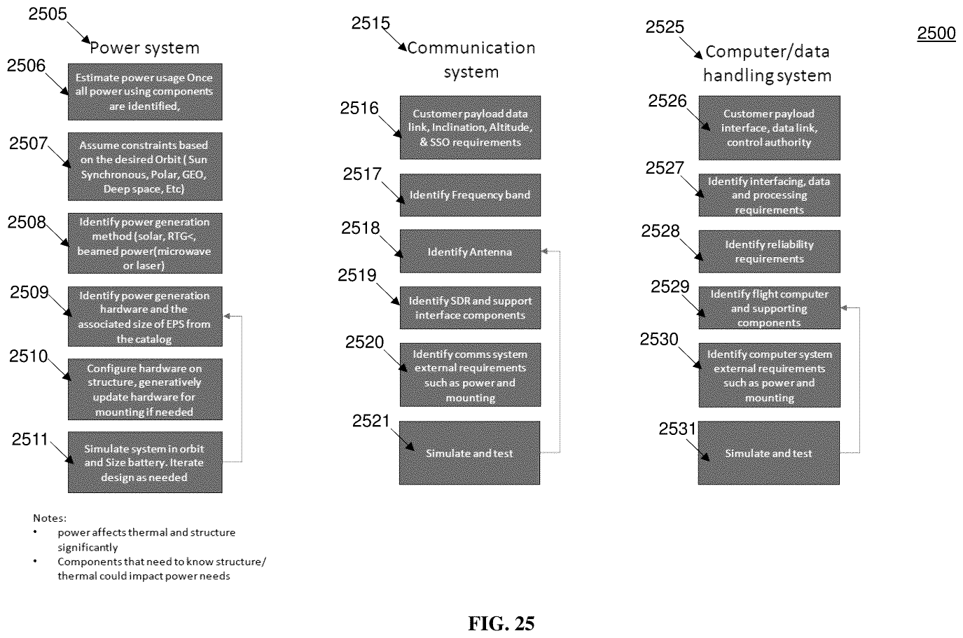

With respect to FIG. 25, a plurality of exemplary subsets 2500 facilitating the configuration or design functionality of the power system 2505, communication system 2515, and computer/data handling system 2525 are shown. By way of example and not limitation, the power system 2505 configuration or design functionality may include an estimation 2506 of power usage once all power-using components have been identified; an assumption 2507 of any relevant constraints based on the desired orbit (such as, for example and not limitation, sun synchronous, polar, geo, or deep space); an identification 2508 of the power generation method (such as, for example and not limitation, solar, RTG, or beamed power, including microwave or laser); an identification 2509 of the power generation hardware and the associated size of the EPS as derived from the catalog, configuration 2510 of the hardware structure, including generatively updating the hardware for mounting, if needed; and simulation 2511 of the system in orbit and the battery size, iterating the design as needed.

In some implementations, by way of further example and not limitation, the communication system 2515 configuration or design functionality may include determination 2516 of the customer payload data link, inclination, altitude, and SSO requirements; an identification 2517 of the frequency band; and identification 2518 of the antenna; an identification 2519 of the SDR and support interface components; an identification 2520 of the external requirements of the communications system, such as power and mounting; and simulation and testing 2521.

In some non-limiting exemplary embodiments, the computer/data handling system 2525 configuration or design functionality may include a determination 2526 of the customer payload interface, data link, and control authority; an identification 2527 of the relevant interfacing, data, and processing requirements; and identification 2528 of the relevant reliability requirements; an identification 2529 of flight computer and supporting components; and identification 2530 of the computer system external requirements such as power and mounting; and simulation and testing 2531.

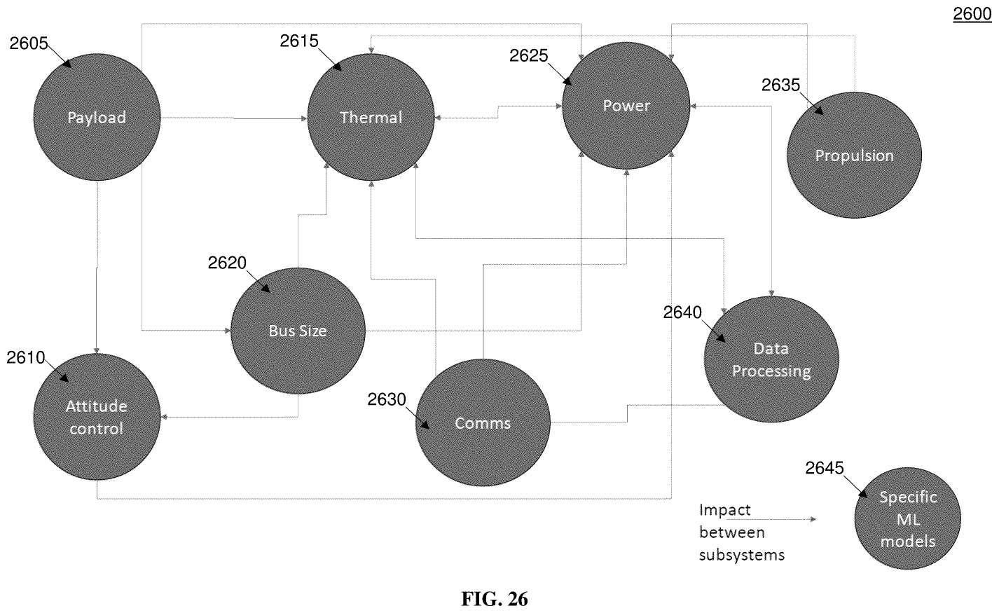

FIG. 26 shows an exemplary process flow 2600 of how generative and user input specific to other subsystems may factor into generative inputs and outputs of other subsystems. Hence, it is evident that each subsystem design is not determined in a vacuum or without considering other subsystems. By way of example and not limitation, the process flow 2600 may include the payload subsystem 2605, the attitude control subsystem 2610, the thermal subsystem 2615, the bus size subsystem 2620, the power subsystem 2625, the communications subsystem 2630, the propulsion subsystem 2635, and the data processing subsystem 2640. In some non-limiting exemplary embodiments, interaction amongst the subsystems may be facilitated by one or more specific machine learning models 2645.

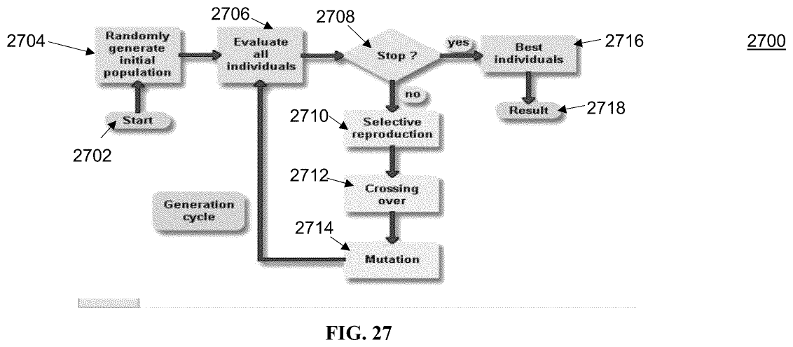

FIG. 27 shows an exemplary embodiment of a genetic algorithm 2700. The genetic algorithm 2700, being readable code operating within a processor, may be used for the processes disclosed above. The genetic algorithm 2700 may allow a multitude of designs to be produced at once and may be used to select an optimized design based on how close the design meets an allowed criterion. This approach is similar to a Pareto frontier in model-based systems engineering where a set of solutions represents the best trade-off between all the objective functions. A solution not dominated by any other solution in the feasible solution space may be considered to be on the Pareto frontier. Thus, this approach may be used for providing manufacturing simplicity or may have criterion focused on reliability. In essence, the approach is not limited to any particular objective.

In some aspects, by way of example and not limitation, the genetic algorithm 2700 begins at 2702 and immediately continues to 2704. At 2704, an initial population is randomly generated. At 2706, all individuals of the initial population are evaluated. At 2708, a determination 2708 is made as whether to stop the algorithm 2700. A negative determination causes the algorithm 2700 to proceed to 2710, while a positive determination causes the algorithm 2700 to proceed to 2716. At 2710, selective reproduction occurs. At 2712, crossing over takes place, while at 2714 mutation occurs. In some aspects, 2714 proceeds back to 2706. At 2716, the best individuals of the population are identified. The genetic algorithm stops at 2718.

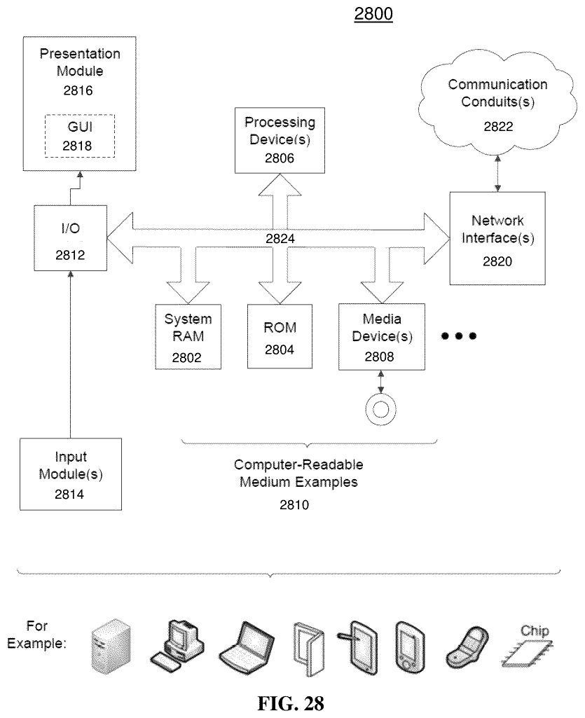

Referring now to FIG. 28, a block diagram of an exemplary computer system, device, or computing functionality, 2800 useful for implementing various aspects the processes disclosed herein, in accordance with one or more embodiments is shown. The computing device may be part hardware or equipment used to provide for the pattern to be moved cyclically in a constant and continuous pattern. In a basic configuration, a computing device 2800 may include any type of stationary computing device or a mobile computing device. As disclosed herein, the AI module is also provided. The computing device may include one or more processors 2806 and system memory 2810 in a hard drive, or media device, 2808. Depending on the exact configuration and type of computing device, system memory 2810 may be volatile (such as RAM), non-volatile (such as read only memory (ROM), flash memory, and the like) or some combination of the two. A system memory 2810 may store an operating system, one or more applications, and may include program data for performing flight, navigation, avionics, power managements operations such as for space operations.

The computing device 2800 may carry out one or more blocks of a process described herein. The computing device may also have additional features or functionality. As a non-limiting example, the computing device may also include additional data storage devices (removable and/or non-removable) such as, for example, magnetic disks, optical disks, or tape. The computer storage media may include volatile and non-volatile, non-transitory, removable and non-removable media implemented in any method or technology for storage of data, such as computer readable instructions, data structures, program modules or other data. The system memory, removable storage and non-removable storage are all non-limiting examples of computer storage media. The computer storage media may include, but is not limited to, RAM, ROM, Electrically Erasable Read-Only Memory (EEPROM), flash memory or other memory technology, compact-disc-read-only memory (CD-ROM), digital versatile disks (DVD) or other optical storage, magnetic cassettes, magnetic tape, magnetic disk storage or other magnetic storage devices, or any other physical medium which can be used to store the desired data, and which can be accessed by computing device. Any such computer storage media may be part of device.

The computing device may also include or have interfaces 2812 for input device(s) 2814 (not shown) such as a keyboard, mouse, pen, voice input device, touch input device, etc. The computing device 2800 may include or have interfaces for connection to output device(s) such as a display, speakers, etc. The computing device may include a peripheral bus for connecting to peripherals. The computing device 2800 may also connect to a presentation module 2816 and a graphical user interface 2818. Computing device 2800 may contain communication connection(s) 2822 that allow the device to communicate with other computing devices, such as over a network or a wireless network via a network interface 2820. By way of example, and not limitation, communication connection(s) may include wired media such as a wired network or direct-wired connection, and wireless media such as acoustic, radio frequency (RF), infrared and other wireless media. The computing device may include a network interface card to connect (wired or wireless) to a network.

Computer program code for carrying out operations described above may be written in a variety of programming languages, including but not limited to a high-level programming language, such as C or C++, for development convenience. In addition, computer program code for carrying out operations of embodiments described herein may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed Digital Signal Processor (DSP) or microcontroller. A code in which a program of the embodiments is described can be included as a firmware in a RAM, a ROM and a flash memory. Otherwise, the code can be stored in a tangible computer-readable storage medium such as a magnetic tape, a flexible disc, a hard disc, a compact disc, a photo-magnetic disc, a digital versatile disc (DVD).

The embodiments may be configured for use in a computer or a data processing apparatus which includes a memory, such as a central processing unit (CPU), a RAM and a ROM as well as a storage medium such as a hard disc.

The “step-by-step process” for performing the claimed functions herein is a specific algorithm, and may be shown as a mathematical formula, in the text of the specification as prose, and/or in a flow chart. The instructions of the software program create a special purpose machine for carrying out the particular algorithm. Thus, in any means-plus-function claim herein in which the disclosed structure is a computer, or microprocessor, programmed to carry out an algorithm, the disclosed structure is not the general-purpose computer, but rather the special purpose computer programmed to perform the disclosed algorithm.

A general-purpose computer, or microprocessor, may be programmed to carry out the algorithm/steps for creating a new machine. The general-purpose computer becomes a special purpose computer once it is programmed to perform particular functions pursuant to instructions from program software of the embodiments described herein. The instructions of the software program that carry out the algorithm/steps electrically change the general-purpose computer by creating electrical paths within the device. These electrical paths create a special purpose machine for carrying out particular algorithm/steps.

Unless otherwise defined, all terms (including technical and scientific terms) used herein have the same meaning as commonly understood by one of ordinary skill in the art to which embodiments belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In particular, unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such data storage, transmission or display devices.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order or importance, but rather the terms first, second, etc., are used to distinguish one element from another. As used herein the expression “at least one of A and B,” will be understood to mean only A, only B, or both A and B.

While various disclosed embodiments have been described above, it should be understood that they have been presented by way of example only, and not limitation. Numerous changes, omissions and/or additions to the subject matter disclosed herein can be made in accordance with the embodiments disclosed herein without departing from the spirit or scope of the embodiments. Also, equivalents may be substituted for elements thereof without departing from the spirit and scope of the embodiments. In addition, while a particular feature may have been disclosed with respect to only one of several implementations, such feature may be combined with one or more other features of the other implementations as may be desired and advantageous for any given or particular application. Furthermore, many modifications may be made to adapt a particular situation or material to the teachings of the embodiments without departing from the scope thereof.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

Therefore, the breadth and scope of the subject matter provided herein should not be limited by any of the above explicitly described embodiments. Rather, the scope of the embodiments should be defined in accordance with the following claims and their equivalents.

We claim:

1. A system for creating a satellite design, comprising:
an input device for a user to input at least one of: a value or situational information related to at least one of: a payload requirement and a mission requirement;
a satellite system design configurator, a satellite system validation subsystem, a dependent requirements generator subsystem, and a cost and completion estimator subsystem, wherein each subsystem comprises at least one processor to provide for a repeatable result based on at least a user input and a generative input as provided by the configurator; and
a viewing device to provide an output for the user to view the results from the configurator.

2. The system of claim 1, wherein the satellite system design configurator is configured to operate autonomously.

3. The system of claim 2, wherein the satellite system design configurator is configured to facilitate an iterative analytical process to provide the repeatable result.

4. The system of claim 1, wherein the repeatable result comprises an optimized satellite design configuration.

5. The system of claim 1, wherein at least one of: the user input and the generative input is provided to the dependent requirements generator subsystem.

6. The system of claim 1, wherein an output from the dependent requirements generator subsystem is provided to the satellite system design configurator.

7. The system of claim 1, wherein an output from the satellite system design configurator is provided to the satellite system validation subsystem.

8. The system of claim 1, wherein an output from the satellite system validation subsystem is provided to at least one of: the satellite system design configurator and the cost and completion estimator subsystem.

9. The system of claim 1, wherein an output from the cost and completion estimator subsystem is provided to the viewing device.

10. A method for creating a satellite design, comprising:
inputting, via an input device, at least one of: a value and situational information related to at least one of: a payload requirement and a mission requirement for a satellite;
generating satellite dependent requirements based on the at least one of: the value and the situational information entered;
creating the satellite design for the satellite with a satellite system design configurator based on the satellite dependent requirements generated;
validating the satellite design; and
presenting the satellite design to a user via a viewing device.

11. The method of claim 10, wherein at least a portion of the dependent requirements are changeable.

12. The method of claim 11, wherein the satellite system design configurator performs an autonomous iterative analysis based on the generated satellite dependent requirements.

13. The method of claim 12, wherein the satellite system design configurator adjusts at least a portion of the changeable dependent requirements during the autonomous iterative analysis.

14. The method of claim 13, wherein the satellite system design configurator continues the autonomous iterative analysis until an optimized configuration is determined for the satellite design.

15. The method of claim 13, wherein adjustments to the at least a portion of the changeable dependent requirements are implemented in real time.

16. The method of claim 10, wherein the created satellite design is repeatable.

17. The method of claim 10, wherein the presented satellite design comprises one or more of: a mass of the satellite, a size of the satellite, a price estimate, and a timeline estimate.

18. The method of claim 10, wherein the presented satellite design comprises a three-dimensional rendering of the satellite.

19. The method of claim 10, wherein the satellite design comprises at least a first satellite design and a second satellite design, wherein an autonomous comparison is performed between the first satellite design and the second satellite design to determine whether the second satellite design comprises an optimized satellite design.

20. The method of claim 19, wherein the second satellite design is autonomously rejected if the second satellite design is determined not to be the optimized satellite design.
